(19) United States
(12) Patent Application Publication
(10) Pub. No.: US 2014/0040325 A1
(43) Pub. Date: Feb. 6, 2014

(54) APPARATUS FOR LOCAL MAINTENANCE DATA STORAGE IN ENERGY CONVERSION INSTALLATIONS

(71) Applicants: Frank Szemkus, Berkenthin (DE); Gernot Pohlmann, Curau (DE)

(72) Inventors: Frank Szemkus, Berkenthin (DE); Gernot Pohlmann, Curau (DE)

(73) Assignee: DeWind Europe GmbH, Lubeck (DE)

(21) Appl. No.: 14/000,138

(22) PCT Filed: Feb. 3, 2012
(86) PCT No.: PCT/EP2012/051906

§ 371 Date: Oct. 21, 2013

(30) Foreign Application Priority Data
Feb. 18, 2011 (DE) 10 2011 000 823.3

(51) Int. Cl. G06F 17/30

(52) U.S. Cl. CPC G06F 17/30292
USPC 707/812

(57) ABSTRACT

An apparatus for capturing and storing data from the maintenance or repair of energy conversion installations is improved in respect of long-term and secure storage and evaluation of the documentation data independently of the operator of the energy conversion installation. At least one energy conversion installation is provided with a maintenance database for storing documentation data from maintenance or repair. At least one mobile user appliance is provided for inputting documentation data into the maintenance database by a user performing the maintenance work. The mobile user appliance has an appliance database used to store individual identification data. The documentation data from maintenance or repair is capable of being stored together with the identification data from the appliance database of the mobile user appliance in the maintenance database of the energy conversion installation, and being remotely retrievable for evaluating on an external evaluation station and transmitting to the evaluation station.

The present invention relates to a system for capturing and storing data related to the maintenance or repair of energy conversion facilities, particularly wind energy facilities.

Nowadays, distributed energy conversion facilities are incorporated in increasingly dynamic monitoring and operating environments that comprise, on the one hand, the service organizations tasked with performing the maintenance and repair work and, on the other hand, the operator organizations. Until recently, such facilities were equipped with stationary operating terminals; however, the current trend favors the use of mobile, customized devices, such as notebooks, netbooks, webpads or even smartphones to monitor the facilities and control tasks.

DE 10 2008 046 156 A1 teaches the use of such a device in connection with the diagnostic monitoring of wind energy facilities. The devices therein are used for monitoring, controlling and receiving error codes in the event of a service disruption.

Any maintenance and repair work that is performed by a service organization must be documented, particularly with regard to any use of replacement parts, resources and other materials. Labor that is performed is also documented, wherein it is recorded, in particular, what type of work was done and on what facility. Special events or observations by the service personnel are recorded as well. Finally, the aforementioned data are used to create service reports that help the service company capture maintenance data for their own technical company databases, on the one hand, we well as for accounting systems in relation to the services supplied to the operator, on the other hand. The operators and, if need be, the owners of the energy conversion facilities are provided with service reports.

Over time, however, service organizations may change. This is usually associated with changes in terms of structure, format and content of the service reports that represent the maintenance data. Changes in the service reporting are also possible, when an operator or owner of a given facility changes, and the new operator or owner sets different requirements. Consistent capturing of maintenance data for a certain local energy conversion facility over long periods of time that is independent of the currently active service company is therefore not available, which poses a problem for the operators and stakeholders of such facilities. In particular, when a service company changes, generally, only the given predecessor company has knowledge of the work that has been completed to date, or such data is only available through the operator of the facility, provided that such data are complete at all. The new service organization must then work up old maintenance data and import such data into their own data inventories to generate an overview of past work as well as a record of replacement parts that have been incorporated, seeking to arrive at a record that is as complete as possible and does not leave gaps. The related time and financial commitments are considerable, which is why many service organizations avoid these steps. However, if old data are not taken over at all, or only for a certain historical time period, it is no longer possible at all, or only with great difficulty, to ensure a gapless follow-up record accompanying any maintenance work that was done or regarding the materials that were installed or consumed after the start-up of the facility.

The situation is similar when there is an operator change. In this instance as well, maintenance data must be procured from the previous operator or the related service company that is involved and must then be integrated in the data infrastructure of the new operator. These efforts are associated with great time and financial commitments and, therefore, often neglected.

Consequently, it is the object of the present invention to provide a system for capturing and storing data related to the maintenance or repair of energy conversion facilities that will allow for providing long-term, gapless and complete data for use by service companies, operators, owners and other stakeholders.

The invention achieves this object by providing that at least one energy conversion facility has a maintenance database for storing documentation data from a maintenance or repair task, that at least one mobile user appliance is provided for the input of documentation data into a maintenance database by a user who performs the maintenance task, and that said mobile user appliance includes an appliance database that can be used for saving individual identification data, that the documentation data from a maintenance or repair task can be stored, together with the identification data from the appliance database of the mobile user appliance, in the maintenance database of the energy conversion facility, and that said data are remotely retrievable by an external evaluation station for and can be evaluated by the same, and that the data can be remotely transmitted to the evaluation station.

Due to the decentralized storage of the documentation data in the maintenance database of the energy conversion facility, said data remain available for all stakeholders, even after a change of the service company, operator, owner or other stakeholders of the energy conversion facility. Mobile user appliances simplify the input of documentation data into the maintenance database by the user, because the user always operates, independently of the presently serviced energy conversion facility, his or her own, familiar mobile user appliance or a similar appliance and does not need to learn how to operate varying local input devices that may be in use at the locale of the respective energy conversion facility. This helps to avoid errors and improves security. With the customized identification data that are stored in the appliance database, it is ensured that only eligible users are able to input documentation data and that it is transparent at a later time who performed the maintenance work and who entered the documentation data into the maintenance database, because the documentation data from a maintenance or repair task are stored in the maintenance database together with the identification data from the appliance database of the mobile user appliance.

Due to the capacity for remote retrieval of the documentation data that are stored in the maintenance database by an external evaluation unit, it is possible to make the maintenance data available to all involved stakeholders without the need for a personal presence at the energy conversion facility. For example, the involved service company can retrieve data and use the same as a basis for creating a standardized service report that can be forwarded to the other stakeholders. However, the service organization is also able to access historical data that were stored previously by former service organizations.

A preferred embodied example of the invention provides that the mobile user appliances are set up for reading operating data from a control device for controlling and regulating the energy conversion facility, working up operating data and storing worked up operating data as a component of the documentation data as set up in the maintenance database of the energy conversion facility. This way, the user receives the operating data of the energy conversion facility on his or her personal mobile user appliance and is able to save said data in the maintenance database for documentation purposes, if necessary, particularly after a routinely implemented work-up step. Such operating data can comprise, in particular, the status of the facility at the time that the maintenance measure was performed, such as operating disturbances, wear and tear, production hours and total production of the energy conversion facility.

Due to the fact that the mobile user appliances are set up for receiving the manual input of maintenance or repair data by the user and for storing data entered in this manner as a component of the documentation data in the maintenance database of the energy conversion system, the user has the option of entering details as to the course of the maintenance work and any related observations in the mobile user appliance first, subsequently storing the information in the maintenance database. In particular, such data can comprise the date, point in time, type, purpose, course and the duration of maintenance or repair work, as well as any related consumption of materials and resources as well as replacement parts that are installed in the context of the maintenance or repair measure.

Preferably, the identification data that are stored in the appliance database of the mobile user appliance comprise also appliance data for identifying the mobile user appliance itself, such as particularly the appliance name, appliance class, manufacturer, serial number and IP address. This provides a vehicle for keeping track of as to what mobile user appliance was used for what maintenance task. With personal mobile user appliances, it is also possible to draw conclusions as to the identity of the user who was tasked with the maintenance work.

However, it is possible to improve the invention in this specified aspect even further by providing that the identification data comprise the user data of the user and of the mobile user appliance, preferably name, address, company affiliation, authentication data, particularly user name, password, PIN codes, validity period of a customized authentication, as well as the access level. This way it is clearly recorded who performed a given maintenance task and what level of authorization such a person was holding at the time when the work was completed.

Supplementing the previously mentioned steps, it is proposed that the identification data further comprise company data of the organization tasked with performing the maintenance and repair work, preferably the company name, address, authentication data and validity period of such an authentication held by the company.

If legitimization is required to gain access to the energy conversion facility or the control device or database, particularly the maintenance database, it is proposed that the identification data also comprise access specification data, particularly, access codes. The related advantage lies in the fact that service personnel does not need to keep the access codes available and enter said codes personally.

The measure that was referred to last can be further improved by providing that the identification data can be stored and/or transmitted as encrypted data. This way, it is ensured that the identification data cannot be easily extracted by persons from outside of the company or persons without proper authorization.

The invention can be improved still further by providing that the appliance database comprise a first data group that is stored in a first storage means, which is disposed in the mobile user appliance, that the appliance database comprise a second data group that is saved in a second storage means, which is detachably connected to the mobile user appliance, and wherein the first data group that was referred to comprises the appliance data for identifying the mobile user appliance, and the second data group comprises the user data for the user. The second storage means therein, which is connected to the appliance, is preferably configured as a USB stick, chip card or a commonly used memory card.

Advantageously, with this measure, the appliance-related part of the appliance database that is used by several individuals remains inside the appliance, while the personal part of the mobile data carrier can always be taken along by the respective service technician, even when said technician is not using the appliance at a given time. To use the mobile user appliance, the service technician inserts his or her personal mobile data carrier (USB stick, etc.) into the appliance, and the appliance software then combines the personal data and the appliance data, thereby facilitating the connection to the maintenance database. After completing the work with the mobile appliance, the service technician removes his or her mobile data carrier from the appliance handing the mobile appliance off to the next user or depositing the same to allow other persons to use it, while the technician takes the mobile data carrier along which him or her. This way, it is possible for several service technicians to use the same mobile user appliance (in succession). Furthermore, it is even possible to install the appliance in a stationary manner, such that it is no longer mobile, while still capturing each active service technician individually.

An embodiment of the invention provides that the mobile user appliances are notebooks with internet connection, netbooks, webpads or smartphones that are loaded with corresponding software for operating, monitoring and creating the aforementioned documentation data, saving the identification data, as well as transmitting documentation data and identification data to a maintenance database of an energy conversion facility. The mentioned appliances can be procured easily and at low cost; with a suitable software product, they can be easily and quickly set up to carry out the specific tasks as provided by the present invention.

A further embodiment of the invention provides for the energy conversion facility to include a communication interface for standardized data exchanges between the mobile user appliances and the maintenance database, as well as for the remote transmission of data from the maintenance database to an external evaluation station. Advantageously, a single communication interface serves for the data exchanges with the mobile user appliances when performing maintenance or repair work on site, on the one hand, as well as for the remote transmission of data for the purpose of evaluating data at an external evaluation station, on the other hand.

In this context, it is particularly beneficial for the external evaluation station to be set up for retrieving documentation data from the maintenance databases of a plurality of energy conversion facilities. For example, in this case, it is possible to combine the administration of all energy conversion facilities of an energy park, particularly a wind energy park, into a single centralized evaluation station.

An improvement of the invention advantageously provides for the communication interface to include a software component for the communication on the software application level, supporting an industry standard or a standard for the data management with regard to maintenance work in energy conversion facilities. The uniform access to the maintenance database, which could be technologically based on web services, supports the interchangeable quality of the maintenance database and mobile user appliances accessing the same.

An improvement of the present invention provides that, aside from numbered and text materials, the maintenance database is also able to save other media formats, particularly audio material, film material and photos, which are retrievable by correspondingly authorized evaluation stations, for example by the operator or manufacturer of the energy conversion facility or by a service company that has been tasked with performing maintenance and repair work. Using the aforementioned multimedia vehicles, it is possible to document operational states and document, in particular, operational disturbances inside the energy conversion facility, particularly when handled by the service technician during the completion of maintenance or repair work. For example, it is possible to take photos of damaged parts, document operational deviations or the operation within parameters, or to record operating noises, for example of a defective bearing, in an audio file format and store such information in the maintenance database. It is understood that such media files can also be generated and saved automatically, in the absence of a service technician, provided the locations that are to be monitored are equipped with microphones and/or digital cameras.

A further improvement of the invention provides that files can be transmitted from the maintenance database to a mobile user appliance for storage inside an appliance database in order to verify that maintenance or repair work was in fact performed. To this end, it is possible to program a microprocessor, which administers the maintenance database, in such a way that said processor checks for the presence of certain maintenance data and the content thereof, generating a corresponding code, once the presence of the related envisioned data has been confirmed, that is transmitted to the mobile user appliance where the code is stored inside the appliance database as verification of the respective maintenance details.

An improvement of the invention provides that evaluation reports and/or status analyses of the respective energy conversion facility can be created in the evaluation station based on the transmitted documentation data. This helps with simplifying the readability and interpretation of documentation data for the intended addressee.

If maintenance reports and/or status analyses can be transmitted to the respective energy conversion facility by the evaluation station for storage inside the maintenance database, all involved stakeholders are able to access such data, even after a long period of time has passed.

An embodiment of the present invention will be illustrated below based on the drawing. The single drawing shows in detail:

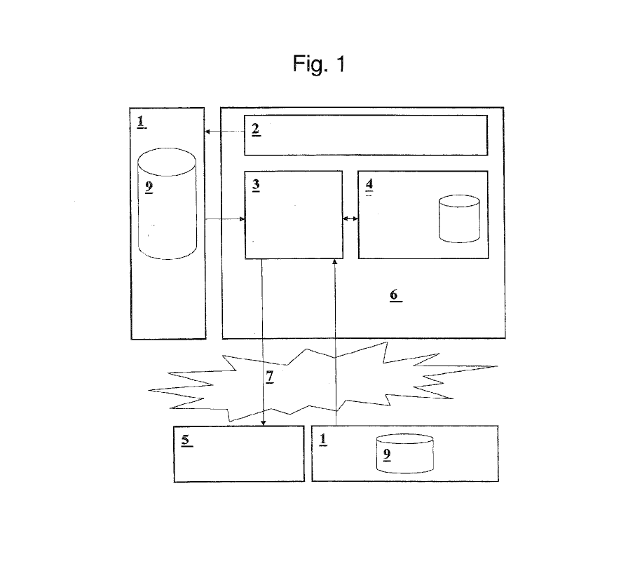

FIG. 1 is a schematic view of a representation of the apparatus according to the invention.

The apparatus as depicted in FIG. 1 serves for capturing and storing data related to maintenance or repair tasks at energy conversion facilities, presently wind energy facilities. In FIG. 1, the wind energy facility 6 is represented by a large rectangle. Aside from the parts of the facility that are can be neglected in this context as they are presently of minor importance, for example rotor, transmission and generator, the depicted wind energy facility 6 has a decentralized maintenance database 4 for storing documentation data from a maintenance or repair task. In particular, a mobile user appliance 1 is provided for saving the data, and said appliance is operated by the service technician. The service technician is able to manually enter maintenance data by means of the mobile user appliance 1, particularly date, point in time, type, purpose, course and duration of the maintenance work, data regarding the consumption of materials and resources, as well as installed replacement parts, and the like. Afterwards, these data can be stored as a component of the documentation data inside the maintenance database 4 of the wind energy facility 6. To this end, the wind energy facility 6 features a communication interface that is connected to the local database 4, on the one hand, and that can be connected to the mobile user appliance 1, on the other hand. For reasons of comfort and easy use, the connection between the mobile user appliance 1 and the communication interface 3 is a wireless connection, particularly a W-LAN or Bluetooth connection.

However, the mobile user appliance 1 can also receive operational data from a control device 2 that is provided for controlling and regulating the wind energy facility 6, if necessary, engage in the work-up of such data and save the same via the communication interface 3 in the maintenance database 4 of the wind energy facility 6. Such data from the control device 2 can relate, particularly, to the given status of the wind energy facility 6 at the time of the maintenance event, such as data regarding operational disturbances or wear and tear of the wind energy facility 6 that have occurred in the past and were filed in an error memory, as well as a data log regarding production hours and the associated energy produced during that time, as well as the total production. All of these operational data can be stored, together with the maintenance data, as documentation data in the maintenance data base 4 of the wind energy facility 6 and retrieved, when needed.

Moreover, each mobile user appliance 1 includes an appliance database 9 where individual identification data are stored. These identification data include, in particular, device data for identifying the respective mobile user appliance 1, user data regarding the user of the mobile user appliance 1, particularly name, address, company association, authentication data and validity period of an individual authentication of the user, also company data regarding the organization that is entrusted with the maintenance work, particularly company name, address, authentication data and validity period of an authentication of the company. In addition, the identification data can comprise, in particular, access codes for the wind energy facility 6, and/or the control device 2, the communication interface 3 and the maintenance database 4 thereof. The identification data are encrypted before being stored in the appliance data base 9, and they are transmitted as encrypted data to the communication interface. Documentation data or other data can only be exchanged with the maintenance data base 4 or the control device 2 or another facility of the wind energy facility 6 after the mobile user appliance 1 and/or the user thereof has been identified and the access authorization is available.

Expedient mobile user appliances 1 are, in particular, notebooks with internet connection, netbooks, webpads or smartphones. With suitable software, such devices can be easily set up to meet the special requirements of the present invention. Aside from being programmable, such devices also offer data storages of sufficient sizes for use as an appliance database 9. Typically, they are set up with facilities allowing to establish a wireless connection via Bluetooth, W-LAN, cellular telephone and UMTS, or they can be set up accordingly. The connection via the cellular telephone network or UMTS is especially pertinent when the mobile user appliance is outside of range of the Bluetooth or W-LAN network, meaning not in the immediate vicinity of the wind energy facility 6. From a large distance, the connection between the mobile user appliance 1 and the wind energy facility 6 can be established via the communication interface 3 thereof, wherein the communication interface 3 is also connected to the cellular telephone network, UMTS or connected to the internet 7 in another way, particularly via a landline telephone connection.

When the wind energy facility 6 is connected via the internet 7, not only the use of a mobile user appliance 1 but also of any evaluation station 5 that is connected to the internet is possible in order to establish the contact with the communication interface 3 of the wind energy facility 6, from anywhere in the world. This way, it is possible to evaluate the documentation data in the maintenance databases 4 of a plurality of wind energy facility 6 by means of a single centralized evaluation station 5. However, other evaluation stations are also able to access the maintenance databases 4 of the wind energy facilities 6, provided they have the corresponding authorizations. For example, the service company, operator, manufacturer or owner of the wind energy facility can each set up one or a plurality of evaluation stations 5, respectively, and retrieve and evaluate the data of the wind energy facilities 6, as well as store worked up data in the respective local maintenance data bases 4 of the wind energy facilities 6, if necessary. These data can also comprise media formats, such as audio material, film material and photos. The maintenance reports or status analyses that are generated by the service company on the basis of the documentation data regarding the individual wind energy facilities 6 can also be stored in the respective, associated local maintenance database 4.

The advantage of the apparatus according to the invention in contrast to the prior art lies in the fact that maintenance data can be made available uniformly, continually and over the long periods of time to all stakeholders, such as operators or service companies, without requiring any added technical complexity; said data are permanently available, even if the service company or the operator of the facility or the mobile user appliances changes. Based on the appliance data from the appliance databases 9 of the mobile user appliances 1, which are stored in the maintenance databases 4 of the wind energy facility 6, it is also possible to provide historical evaluations regarding organizations and other stakeholders that conducted, for example, maintenance work on this wind energy facility 6.

1. An apparatus for capturing and storing data from the maintenance or repair of energy conversion installations, particularly wind energy installations (6), characterized in that at least one energy conversion installation (6) is provided with a maintenance database (4) for storing documentation data from maintenance or repair by virtue of at least one mobile user appliance (1) being provided for the purpose of the input of documentation data from the maintenance database (4) by a user performing the maintenance work, which mobile user appliance includes an appliance database (9) that can be used to store individual identification data, in that the documentation data from maintenance or repair can be stored together with the identification data from the appliance database (9) of the mobile user appliance (1) in the maintenance database (4) of the energy conversion installation (6) and can be remotely retrieved for the purpose of evaluation on an external evaluation station (5), and it can be teletransmitted to the evaluation station (5).

2. The apparatus according to claim 1, characterized in that the mobile user appliance (1) is set up for reading out operating data from a controller device (2) for controlling and adjusting the energy conversion installations (6), for the purpose of working up the operating data and for storing said worked up operating data as a component of the documentation data in the maintenance database (4) of the energy conversion installation (6).

3. The apparatus according to claim 1, characterized in that the mobile user appliances (1) are set up for the manual input of maintenance or repair data by the user and for storing the data, which have been input in this manner, as a component of documentation data in the maintenance database (4) of the energy conversion installations (6).

4. The apparatus according to claim 1, characterized in that the identification data comprise appliance data for identifying the mobile user appliance (1), particularly the name of the appliance, class of the appliance, manufacturer, serial number and IP address.

5. The apparatus according to claim 1, characterized in that the identification data comprise user data of the user of the mobile user appliance (1), preferably name, address, company association, authentication data, particularly user name password, PIN codes, validity period of an individual authentication and access level.

6. The apparatus according to claim 1, characterized in that the identification data comprise the data of the company tasked with performing the maintenance or repair work, preferably the company name, address, authentication data and validity period of an authentication of the company.

7. The apparatus according to claim 1, characterized in that the identification data comprise access specification data, particularly access codes.

8. The apparatus according to claim 1, characterized in that the identification data are encrypted before they are stored and/or transmitted.

9. The apparatus according to claim 4, characterized in that the appliance database comprises a first data group that is stored in a first storage means, which is disposed in the mobile user appliance (1), in that the appliance database comprises a second data group that is stored in a second storage means, which is detachably connected to the mobile user appliance (1), wherein the named first data group comprises the appliance data for identifying the mobile user appliance (1) and the second data group comprises the user data of the user.

10. The apparatus according to claim 9, characterized in that the second storage means that is connected to the mobile user appliance (1) is configured as a USB stick, a chip card or a common memory card.

11. The apparatus according to claim 1, characterized in that notebooks with internet connection, netbooks, webpads or smartphones are used as mobile user appliances (1) that are equipped with corresponding software for operating, monitoring and creating the aforementioned documentation data, for the storage of the identification data, as well as for the transmission of the documentation data and identification data to a maintenance database (4) of an energy conversion installation (6).

12. The apparatus according to claim 1, characterized in that the energy conversion installation (6) includes a communication interface (3) for the standardized data exchange between the mobile user appliance (1) and the maintenance database (4) and for the teletransmission of data from the maintenance database (4) to an external evaluation station (5).

13. The apparatus according to claim 12, characterized in that the external evaluation station (5) is set up for retrieving the documentation data of a plurality of energy conversion installations (6) from the maintenance databases (4).

14. The apparatus according to claim 12, characterized in that the communication interface (3) includes a software component for the communication on the software application level, which supports an industry standard or a standard for the data management of maintenance work in energy conversion installations (6).

15. The apparatus according to claim 1, characterized in that the maintenance database (4) is able to store, aside from number and text material, other media formats as well, particularly audio material, film material and photos, that can be retrieved via authorized evaluation stations (5), for example by the operator or manufacturer of the energy conversion installation (6) or a service company tasked with the maintenance or repair work.

16. The apparatus according to claim 1, characterized in that the files from the maintenance database (4) can be transmitted to a mobile user appliance (1) for storage in the appliance database (9) for verification purposes that the maintenance or repair work was indeed performed.

17. The apparatus according to claim 12, characterized in that maintenance reports and/or status analyses of the related energy conversion installation (6) can be created in the evaluation station (5) based on the transmitted documentation data.

18. The apparatus according to claim 17, characterized in that the evaluation station (5) is able to transmit the maintenance reports and/or status analyses (5) for storage in the maintenance database (4) to the related energy conversion installation (6).
